(19) United States
(12) Patent Application Publication
(10) Pub. No.: US 2006/0190532 A1
(43) Pub. Date: Aug. 24, 2006

(54) Apparatus and methods for multiple user remote connections to an information handling system via a remote access controller

(76) Inventor: Kalyana Chadalavada, Bangalore (IN)

Correspondence Address: O'KEEFE, EGAN & PETERMAN, 1101 CAPITAL OF TEXAS HIGHWAY SOUTH, #C200, AUSTIN, TX, 78746, US

(21) Appl. No.: 11/063,779

(22) Filed: Feb. 23, 2005

(51) Int. Cl. G06F 15/16

(52) U.S. Cl. 709/203

(57) ABSTRACT

An information handling system includes a host computer system, at least one virtual machine, and a remote access controller. The virtual machine(s) runs on the host computer system. The remote access controller is configured to provide simultaneous out-of-band communication between a plurality of users and the host computer system.

### TECHNICAL FIELD

The inventive concepts relate generally to information handling apparatus and systems. More particularly, the invention concerns apparatus and associated methods for providing multiple remote user connections to an information handling or computer system via a remote access controller.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As information handling systems have increased in complexity and processing power, virtualization of various information handling resources has started to become more widespread. Virtualization allows consolidation of resources on a common information handling platform. Current virtualization techniques, however, lack a mechanism for multiple user remote connections to the information handling system using out-of band solutions. As a result, the remote users of the consolidated resources lack a way of simultaneously accessing the information handling resources. A need exists for multiple remote user connections to an information handling or computer system that uses virtualization.

### SUMMARY

The disclosed novel concepts relate to apparatus and methods for providing simultaneous out-of-band communication in an information-handling system. In one embodiment, an information handling system includes a host computer system, at least one virtual machine running on the host computer system, and a remote access controller. The remote access controller provides simultaneous out-of-band communication between a plurality of users and the host computer system.

In another embodiment, an apparatus for providing communication between a plurality of remote users and a host system includes a remote access controller. The remote access controller is configured to communicate with at least one virtual machine implemented on a host system. The remote access controller allows simultaneous out-of-band communication between the plurality of remote users and the virtual machine.

In yet another embodiment, a method of providing simultaneous access to resources of an information handling system includes operating a plurality of virtual machines using the information handling system. The method further includes providing simultaneous out-of-band communication paths, respectively, between users in a plurality of remote users and respective virtual machines in the plurality of virtual machines.

### BRIEF DESCRIPTION OF THE DRAWINGS

The appended drawings illustrate only exemplary embodiments of the invention and therefore should not be considered or construed as limiting its scope. Persons of ordinary skill in the art who have the benefit of the description of the invention appreciate that the disclosed inventive concepts lend themselves to other equally effective embodiments. In the drawings, the same numeral designators used in more than one drawing denote the same, similar, or equivalent functionality, components, or blocks.

FIG. 1 shows an information handling system according to an exemplary embodiment of the invention.

FIG. 2 illustrates additional details of the system shown in FIG. 1.

FIG. 3 depicts more details of a remote access controller according to an exemplary embodiment of the invention.

FIG. 4 shows an arrangement to facilitate communication by remote users with a host system according to an illustrative embodiment of the invention.

FIG. 5 illustrates a process flow for communication between remote users and various information handling resources according to an exemplary embodiment of the invention.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Virtualization allows consolidation of various information handling resources, such as storage, server, print server, network, and the like, on a single information handling system or computer system. Virtualization provides certain benefits over conventional information handling techniques. Virtualization allows increased utilization of resources in a data center or information handling center. Use of virtualization results in better utilization of existing resources, thus eliminating or delaying the need for more physical resources, such as servers and storage. Consequently, the user experience a better return on investment and lowered TCO by implementing virtualization.

A typical information handling system that uses virtualization uses a single physical computer system to implement virtualization. A plurality of virtual machines running on the single physical system (host system) provide the infrastructure for the information handling system with virtualization. Each of the virtual machines may run a desired operating system.

The host system runs the plurality of virtual machines using a host operating system. Because of the nature of virtualization, administrators of the virtual machines typically do not reside in the same physical location as the host system. As a result, in conventional approaches (e.g., VMWare ESX, VMWare GSX), merely one remote user interacts with a virtual resource, for example a virtual machine. Put another way, conventional approaches do not provide a mechanism for out-of-band multiple-user access. As a result, conventional approaches tend to limit one of the benefits of virtualization, i.e., consolidation of resources.

The inventive concepts disclosed here provide a host-operating-system-independent mechanism for multiple users (e.g., the administrators of the virtual machines) to remotely access the single physical information handling system (host system) that hosts the plurality of virtual machines. Moreover, the user need not install any specific software (such as VMWare client or Microsoft Virtual Server client) to take advantage of the benefits of the invention.

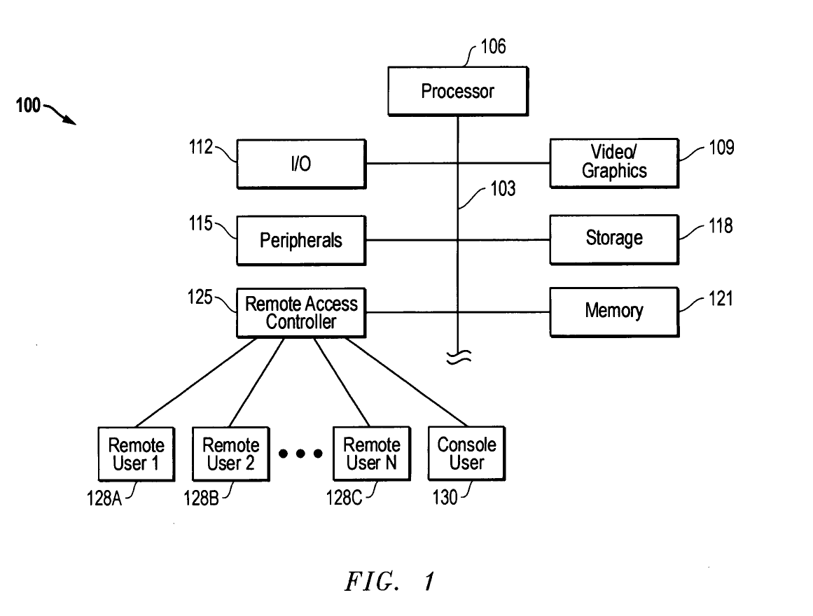

FIG. 1 shows a host system 100 according to an exemplary embodiment of the invention. System 100 includes one or more processors 106, one or more buses or communication media 103, video/graphics hardware 109, storage 118, memory 121, input/output (I/O) 112, peripherals 115, and remote access controller 125. Bus 103 provides a mechanism for the various components of system 100 to communication and couple with one another and thus acts as the backbone of the system. Processor 106, video/graphics 109, storage 118, memory 121, I/O 112, and peripherals 115 have the structure, and perform the functions, familiar to persons of ordinary skill in the art who have the benefit of the description of the invention.

Note that FIG. 1 provides merely an illustrative architecture of system 100. One may readily use alternative architectures or structures, and yet take advantage of the inventive concepts, by making modifications that fall within the knowledge of persons of ordinary skill in the art who have the benefit of the description of the invention.

Remote access controller 125 accommodates access by a plurality of remote users 128A-128C, as well as console user 130 (for host system 100) by incorporating the inventive concepts. Console user 130 can control and administer resources within system 100. Remote access controller 125 allows remote users to manage various resources of host system 100 (either native or virtual) from a remote location, as described below in detail. Remote access controller 125 facilitates out-of-band access to various resources of system 100. Out-of-band solutions provide access in situations where the remote user does not have a connection to system 100 through a local area network, for example, in situations where the remote user uses a telephone line and modem to access system 100.

In illustrative embodiments, remote access controller 125 may constitute a Dell Remote Access Controller (DRAC), available from Dell Inc., the assignee of this patent application. Note, however, that one may use other suitable remote access controllers, as persons of ordinary skill in the art who have the benefit of the description of the invention understand.

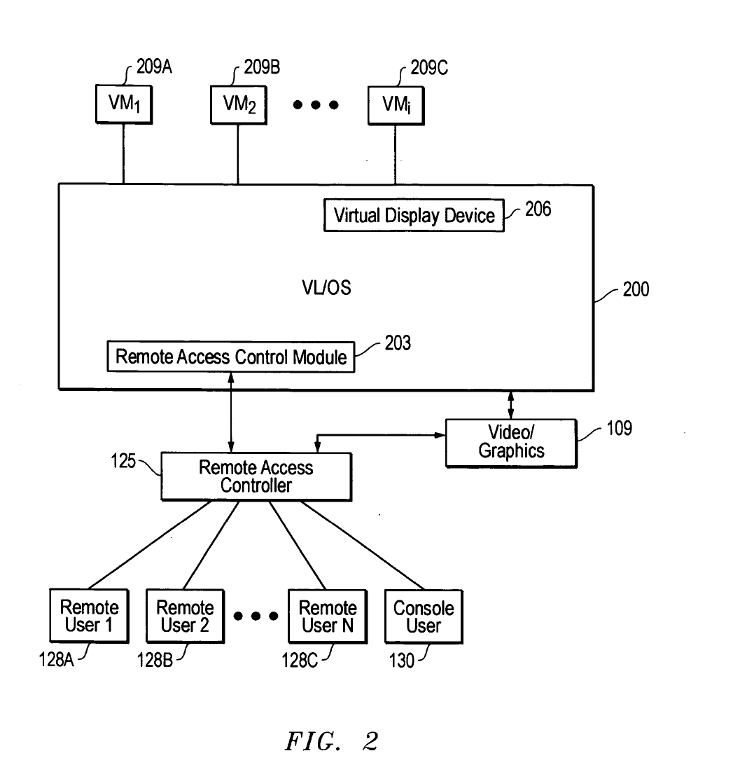

FIG. 2 illustrates more details of host system 100, shown in FIG. 1. More specifically, FIG. 2 shows how virtualization layer 200 within system 100 interacts with various components of system 100, including video/graphics hardware 109, remote access controller 125, a plurality of virtual machines 209A-209C, remote access control module 203, and virtual display device 206. Virtual machines 209A-209C allow emulation of resources on system 100, such as operating systems, software, and/or hardware, as desired.

Virtualization layer 200 facilitates implementation of virtualization within system 100. Virtualization layer 200 may take a variety of forms. In one case, virtualization software may run on a general-purpose or special-purpose operating system. For example, virtualization software may run on the Microsoft Windows or the Linux operating systems, although one may use a wide variety of operating systems and virtualization software, as persons of ordinary skill in the art who have the benefit of the description of the invention understand. FIG. 2 shows such an example, and denotes virtualization layer 200 and the host operating system as “VL/OS.” In another case, virtualization layer 200 may include a special-purpose virtualization operating system that runs on the hardware. Note that one may employ the inventive concepts with a variety of virtualization operating systems, as persons of ordinary skill in the art who have the benefit of the description of the invention understand.

Regardless of the particular implementation of virtualization layer 200, virtualization layer 200 allows the realization of virtual machines 209A-209C. As noted above, virtual machines 209A-209C need not run the operating system or software of host system 100. Thus, virtualization layer 200 and virtual machines 209A-209C provide a flexible mechanism for consolidation of resources and accommodation of a wide variety of software and operating systems.

Remote access controller 125 communicates with virtualization layer 200. More specifically, virtualization layer 200 includes remote access control module 203 that coordinates and facilitates communication with remote access controller 125. By using remote access control module 203, virtualization layer 200 can communicate with remote users 128A-12bC and console user 130. When a remote user wishes to communicate with (e.g., administer or configure) one of virtual machines 209A-209C, virtualization layer 200, remote access control module 203, and remote access controller 125 provide the communication mechanism.

Virtualization layer 200 also includes virtual display device 206. Virtual display device 206 serves as a display device for virtual machines 209A-209C. Remote access control module 203 can “snoop” on (or tap into, sample, or otherwise obtain the contents) virtual display device 206 by communicating with the display driver that virtual display device 206 uses. Consequently, remote access module 203 can obtain the display contents (e.g., virtual console display information) and provide the contents to a remote user.

Remote access controller 125 couples to video/graphics hardware/circuitry 109. Through that coupling, remote access controller 125 can obtain the display contents for the console of host system 100. Remote access controller 125 can provide the display contents to console user 130. Console user 130 may then communicate with console 130 of host system 100 and administer system 100.

The inventive concepts use time multiplexing to provide communication between system 100 and a plurality of remote users (including console user 130) simultaneously. Put another way, multiplexing the remote users' connections to remote access controller 125 and, hence, system 100, allows each remote user to communicate with, and administer, one of virtual machines 209A-209C.

In exemplary embodiments, the multiplexing takes place within remote access controller module 203. Remote access controller module 203 interacts with virtualization layer 200 and obtains a list of virtual machines 209A-209C running on system 100. As described in detail below, remote access controller module 203 uses the list to facilitate connections of the remote users to virtual machines 209A-209C. The list also provides the capability of a remote user to select the virtual machine with which he or she wishes to communicate.

As an example, suppose that the Linux operating system is running on virtual machine 209A, and that the Microsoft Windows operating system is running on virtual machine 209B. Suppose that remote user 128A wishes to communicate with virtual machine 209A, and that remote user 128B seeks to connect to virtual machine 209B. Suppose further that console user 130 wishes to communicate with, and administer, host system 100 (running, for example, the UNIX operating system). Remote access controller module 203 provides the desired connections between the machines and users.

More specifically, remote access controller module 203 has a list that includes information about each of virtual machines 209A-209C and their respective operational environments (e.g., type of operating system or software running). By using remote access controller 125, remote access controller module 203 provides time-multiplexed communication between the remote users and resources within system 100 (including virtual machines 209A-209C). Thus, remote access controller module 203 facilitates the establishment of a communication path between remote user 128A and virtual machine 209B.

Similarly, through remote access controller module 203, user 128B and user 130 obtain communication paths with virtual machine 209B and system 100 (native operating system and software). Each of the users can now administer the respective virtual machine or system. Because of the time-multiplexed feature of remote access controller 203, the users have simultaneous communication paths to the desired resources.

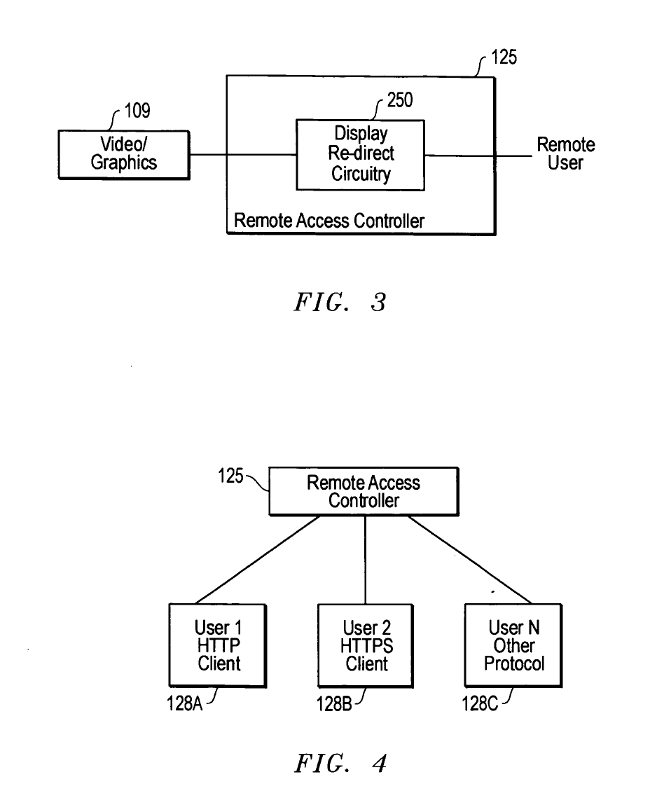

FIG. 3 shows more details of remote access controller 125 according to an exemplary embodiment of the invention. In addition to circuitry and hardware for communicating with remote users (console user 130), and remote access control module 203, remote access controller 125 includes display redirect circuitry 250. Display redirect circuitry 250 communicates with video/graphics hardware 109 and a remote user. Through display redirect circuitry 250, remote access controller 125 can communicate the display contents of the console of host system 100 to console user 130. Access to the display contents of the console facilitates the administration of host system 100 by console user 130.

As noted above, the remote users need not install, run, or use any specialized software on their respective computer systems in order to take advantage of the remote access to host system 100 according to the inventive concepts. In fact, the users may take advantage of existing or standard communication mechanisms and protocols, as desired.

FIG. 4 shows an arrangement to facilitate communication by remote users with host system 100 according to an illustrative embodiment of the invention. The arrangement in FIG. 4 includes example of various protocols that remote users may use to communicate with remote access controller 125 and, hence, system 100.

More specifically, remote user 128A uses the Hyper Text Transfer Protocol, or HTTP (the protocol used by the World Wide Web protocol) to communicate with remote access controller 125. Typical computer systems include browsers with built-in HTTP capability. Remote user 128A can exploit this capability and use his or her browser's HTTP protocol to communicate with system 100 and administer resources of one of virtual machines 209A-209C.

As another example, remote user 129B uses the Hyper Text Transfer Protocol Secure sockets, or HTTPS, to communicate with remote access controller 125. The browser included with a typical computer systems has built-in HTTPS capability. Remote user 128B can use the built-in capability of the browser and communicate with system 100 using the HTTPS protocol. Thus, similar to remote user 128A, remote user 128B can administer resources of one of virtual machines 209A-209C.

Note that the HTTPS protocol allows secure communication between remote user 128B and system 100. The secure communication can facilitate tasks such as authentication of remote user 128B, transmission of sensitive information (such as server configuration or access rights of various users) between host system 100 and remote user 128B, as desired.

If desired, one may use other protocols to communicate with system 100. For example, user 128C may wish to use a protocol other than HTTP or HTTPS to access system 100. The inventive concepts contemplate the capability within remote access controller 125 to accommodate additional or different protocols, as desired. This capability provides the remote user with a flexible mechanism to communicate with system 100. Similarly, console user 130 may use a standard or any other desired protocol to communicate with, and administer, system 100.

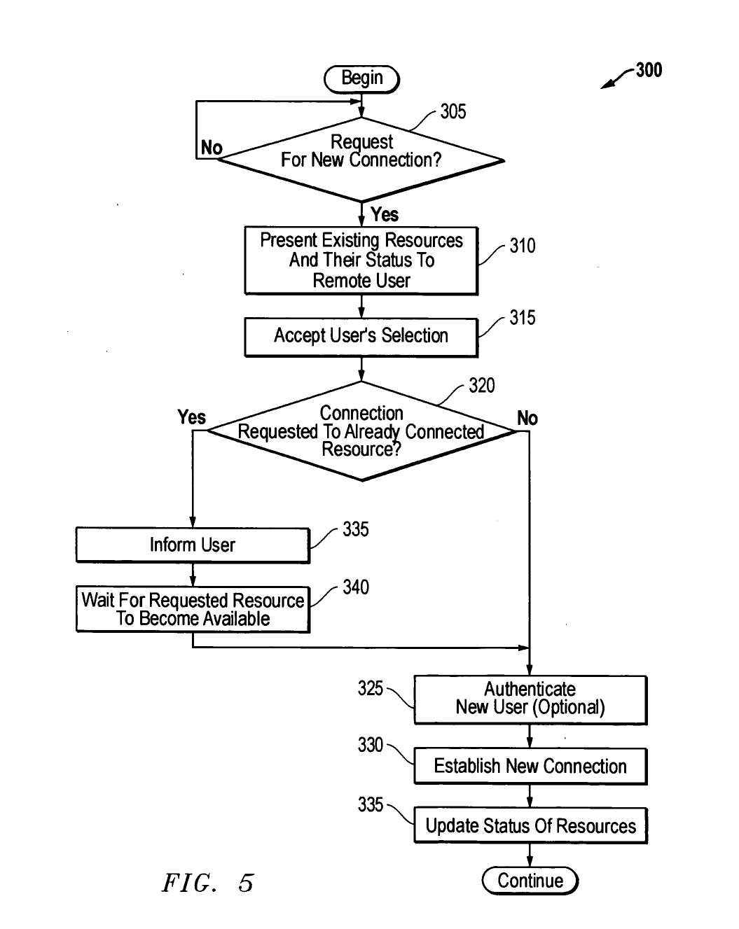

FIG. 5 shows a process flow 300 for communication between remote users and various information handling resources according to an exemplary embodiment of the invention. Starting at 305, the system (specifically, remote access controller module 203) checks to determine whether a remote user seeks to establish a new connection. If not, the process returns to 305. If a request for connection exists, the process continues at 310.

At 310, the system presents information to the requesting user about the existing resources (e.g., virtual machines 209A-209C, host system 100, etc.). The information may take a variety of forms, such as the existence and status of each resource, as persons of ordinary skill in the art who have the benefit of the description of the invention understand. Note that one may present the information in a variety of ways, as desired, such as a menu that allows selection by the user, as persons of ordinary skill in the art who have the benefit of the description of the invention understand.

At 315, the system accepts the user's selection. At 320, the system checks to determine whether the user has requested to communicate with a resource with which another user has already established a connection (e.g., another user has logged on to the desired resource and has begun administration of that resource). If so, at 335, the requesting user receives notification of the unavailability of the requested resource. Subsequently, the system waits 340 in order for the requested resource to become available.

Note that one may use authorization schemes to give various users different levels of priority, as desired, and provide access to resources accordingly. Suppose, for example, that user 128A has established access to virtual machine 209A. Suppose further that user 128B later (or simultaneously) seeks access to virtual machine 209A, and that user 128B has higher priority than user 128A. Rather than wait for user 128A to relinquish control of virtual machine 209A (as described above), the system may instead give access to virtual machine 209A to user 128B because of that user's higher priority. In this situation, the system may disconnect user 128A from virtual machine 209A or may make user 128 a viewer, as desired. Note that one may use a wide variety of other schemes that fall within the knowledge of persons of ordinary skill in the art who have the benefit of the description of the invention.

Referring to FIG. 5, if the requested resource is available, at 325 the system may perform an optional authentication procedure. For example, the system may obtain information about the user or check the user's rights or privileges to determine whether the user may establish access and what actions the particular user may perform. At 330, (depending on the results of authentication, if performed) the system establishes a new connection for the requesting user to the desired resources. At 335, the system updates the status of various resources (e.g., which user has a communication path with which resource, etc.).

Referring to the figures, persons of ordinary skill in the art will note that the various blocks shown may depict mainly the conceptual functions and signal flow. The actual circuit implementation may or may not contain separately identifiable hardware for the various functional blocks and may or may not use the particular circuitry shown. For example, one may combine the functionality of various blocks into one circuit block, as desired. Furthermore, one may realize the functionality of a single block in several circuit blocks, as desired. The choice of circuit implementation depends on various factors, such as particular design and performance specifications for a given implementation, as persons of ordinary skill in the art who have the benefit of the description of the invention understand. Other modifications and alternative embodiments of the invention in addition to those described here will be apparent to persons of ordinary skill in the art who have the benefit of the description of the invention. Accordingly, this description teaches those skilled in the art the manner of carrying out the invention and are to be construed as illustrative only.

The forms of the invention shown and described should be taken as the presently preferred or illustrative embodiments. Persons skilled in the art may make various changes in the shape, size and arrangement of parts without departing from the scope of the invention described in this document. For example, persons skilled in the art may substitute equivalent elements for the elements illustrated and described here. Moreover, persons skilled in the art who have the benefit of this description of the invention may use certain features of the invention independently of the use of other features, without departing from the scope of the invention.

1. An information handling system, comprising:
a host computer system;
at least one virtual machine running on the host computer system; and
a remote access controller, the remote access controller configured to provide simultaneous out-of-band communication between a plurality of users and the host computer system.

2. The information handling system according to claim 1, wherein a first user communicates with, and administers, the at least one virtual machine.

3. The information handling system according to claim 2, wherein a second user communicates with, and administers, the host system.

4. The information handling system according to claim 1, wherein the host system further comprises a virtualization layer running on the host system.

5. The information handling system according to claim 4, wherein the virtualization layer further comprises a remote access controller module, the remote access controller module configured to provide simultaneous communication between the plurality of users and the host computer system.

6. The information handling system according to claim 5, wherein the remote access controller module uses time multiplexing to provide simultaneous communication between the plurality of users and the host computer system.

7. The information handling system according to claim 1, wherein the plurality of users communicate with the host computer system using Hyper Text Transfer Protocol (HTTP) or Hyper Text Transfer Protocol Secure sockets (HTTPS).

8. The information handling system according to claim 1, further comprising video/graphics hardware coupled to the remote access controller, the video/graphics hardware configured to redirect display information to the plurality of remote users.

9. An apparatus for providing communication between a plurality of remote users and a host system, comprising:
a remote access controller configured to communicate with at least one virtual machine implemented on a host system,
wherein the remote access controller allows simultaneous out-of-band communication between the plurality of remote users and the at least one virtual machine.

10. The apparatus according to claim 9, wherein the remote access controller is configured to communicate display information from a virtual display device to the plurality of remote users.

11. The apparatus according to claim 10, wherein the remote access controller samples display information from the virtual display device.

12. The apparatus according to claim 10, wherein the remote access controller comprises redirect circuitry, the redirect circuitry configured to communicate console display information between video/graphics hardware and a remote user in the plurality of remote users.

13. The apparatus according to claim 12, wherein the redirect circuitry is configured to communicate console display information from a console of the at least one virtual machine.

14. The apparatus according to claim 12, wherein the redirect circuitry is configured to communicate console display information from a console of the host system.

15. A method of providing simultaneous access to resources of an information handling system, the method comprising:
operating a plurality of virtual machines using the information handling system; and
providing simultaneous first and second out-of-band communication paths, respectively, between first and second users in a plurality of remote users and first and second virtual machines in the plurality of virtual machines.

16. The method according to claim 15, further comprising time multiplexing the first and second communication paths.

17. The method according to claim 16, further comprising:
communicating display information from the first virtual machine to the first user by using the first communication path; and
communicating display information from the second virtual machine to the second user by using the second communication path.

18. The method according to claim 15, further comprising providing a third communication path between a third remote user in the plurality of remote users and a console of the information handling system.

19. The method according to claim 15, wherein providing simultaneous first and second communication paths further comprises:
generating a list of the resources of the information handling system;
receiving a request from the first user for access to the resources of the information handling system;
presenting the list of resources to the first remote user;
accepting from the first remote user a selection from the list of resources; and
providing access by the first remote user to the selected resource of the information handling system.

20. The method according to claim 19, further comprising authenticating the first remote user.
